(19) United States
(12) Patent Application Publication
(10) Pub. No.: US 2012/0126981 A1
(43) Pub. Date: May 24, 2012

(54) THEFT PREVENTION SYSTEM

(75) Inventors: Richard Bawamia, Mansfield (GB); Steve Peru, Provins (FR)

(73) Assignee: TAG Company (UK) Ltd, Harmondsworth (GB)

(21) Appl. No.: 13/219,055

(22) Filed: Aug. 26, 2011

(30) Foreign Application Priority Data
Aug. 27, 2010 (GB) 1014272.7

(51) Int. Cl. G08B 13/14

(52) U.S. Cl. 340/568.1

(57) ABSTRACT

A system for detecting removal of an item from storage shelving includes a sensor or series of sensors located on the shelving where items are positioned, each sensor being located so as to be associated with a single item, and each sensor being operable in response to movement of an associated item to generate a system signal including the location of that sensor, and a monitoring device to which the sensors are connected, configured to receive the system signal and to generate a predetermined warning signal in response to the system signal.

### RELATED APPLICATIONS

This application claims the benefit of British Patent Application No. GB 1014272.7 filed Aug. 27, 2010, which application is incorporated by reference herein in its entirety.

### TECHNICAL FIELD

This invention relates to methods and systems for use in detecting possible theft of items such as may be used in retail establishments.

### BACKGROUND

There have been a number of proposals for preventing theft of items from retail establishments or for preventing theft and/or unauthorized removal of items in other environments including but not limited to warehouses and distribution centers. Direct observation, either by staff on the shop floor, or via closed circuit TV systems can be effective but becomes difficult where the retail establishment is very large.

One method of addressing this issue in known as electronic article surveillance (EAS) and comprises attaching a device to an article that can set off an alarm if it is removed from a specific location. A number of EAS systems have been proposed, based on different electronic principles. These can be useful where it is relatively easy to attach the device (tag) to the article, or article packaging, and detect when it is moved from a location. Deactivation of the tag is achieved by passing the tag close to a deactivation device, such as a pad that emits a predetermined electric field. Such systems are difficult to use if the article masks the tag signal, or cannot be easily passed by a deactivation device.

Other security systems include the use of alarmed tethers of display cupboards that must be deactivated or unlocked before the article can be removed. These are difficult to use with relatively large products.

Another proposal, described in US2005/0161420, involves the use of alarmed movable barriers on shelving that must be moved to remove the article and so activate alarms if unauthorized removal takes place.

This invention seeks to provide a system that can be used with items that are often sold in a warehouse-like situation from shelving.

### SUMMARY

In some embodiments, the invention pertains to a system for detecting removal of an item from storage shelving. The system includes one or more sensors located on shelving where items are positioned, each sensor being located so as to be associated with a single item, and each sensor being operable in response to movement of an associated item to generate a system signal including the location of that sensor. The system also includes a monitoring device to which the sensors are connected, configured to receive the system signal and to generate a predetermined warning signal in response to the system signal.

In some embodiments, the invention pertains to a method of detecting removal an item from storage shelving that includes operating one or more sensors located on the shelving where items are positioned. Each sensor is located so as to be associated with a single item, to generate a system signal in response to movement of the item, the system signal including the location of the sensor associated with the item being moved. The system signal is received at a monitoring device to which the sensors are connected. A predetermined warning signal is generated in response to the system signal.

In some embodiments, the monitoring device can be configured to output data to a web-based reporting system when the warning signal is generated. The monitoring device can also be configurable to output one or more of a set of predetermined warning signals.

The warning signal can include an electronic message alert to an operator, and/or an audible and/or visual signal which can be generated at or near to the location of the sensor that has generated the system signal leading to the warning signal.

Further aspects of the invention will be apparent from the following description.

### BRIEF DESCRIPTION OF THE DRAWINGS

FIG. 1 shows a schematic view of a system according to an embodiment of the invention.

### DETAILED DESCRIPTION

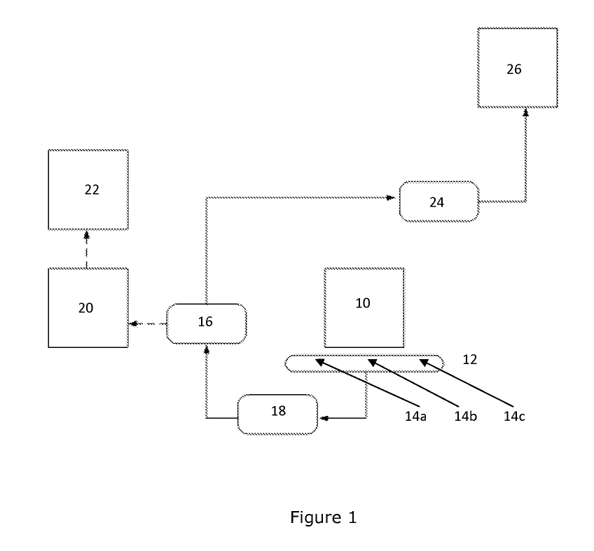

Referring to FIG. 1, a system according to an embodiment of the invention can be applied in a warehouse-type retail outlet that sells large cost items such as but not limited to electrical retailers, home improvement or hardware stores selling items such as household heating boilers or can be applied in a distribution center holding inventory of large cost items. Such stores often have large scale shelving or rack systems for storing the items for sale but that are accessible to the purchasing public as well as the store staff. Such distribution centers often have large scale shelving or rack systems for storing goods also.

In the embodiment shown in FIG. 1, the item in question 10 (for example, a household water heater) is placed in a monitored shelving system 12. The shelving system 12 includes one or more sensors, such as pressure sensors. The embodiment shown in FIG. 1 includes three sensors 14a-c. These can be permanently fixed to the shelving, or moveable such that store staff can position them according to needs. The sensors can be provided with an electrical power connection, or a battery to allow effectively continuous operation. Each item 10 will have at least one sensor 14 associated with it. The sensors 14 are connected to a relay monitoring device 16. This connection can be hard wired, or wireless.

In use, the item 10 will be placed on the shelving 12 and the associated sensor 14 activated. In order to prevent unauthorized de-activation, a secure system can be implemented in which de-activation can only take place from the monitoring device 16, or by means of a secure key or code.

Each active sensor 14 is configured such that movement of the item 10 or the sensor 14, or any tampering with the sensor 14 triggers an alarm event 18 and a system message to be sent from the sensor 14 to the monitoring device 16. The monitoring device 16 and/or the sensor 14 will be configured such that the alarm event involves an indication of the location of the item 10 on the shelving 12.

On reception of the system message, the monitoring device 16 can be configured to respond in one of a number of different ways that can be defined by the user. Responses include initiating a general audible and/or visual alarm signal, either throughout the store or in the section of shelving containing the sensor in question; indicating on a system monitor the location of the sensor 14; triggering an external signal relay so that the alarm is passed to an external monitor, such as in a general office; or sending an electronic message alert to a member of staff The electronic message alert could include e-mails, RSS feeds, texts, tweets or paging messages. Other responses are also possible.

The monitoring device 16 can also be connected to a web-based reporting system 20, such as the Tracker Retail Security Management and Information System of Tag Company UK or other data and event management systems, to monitor and capture alarm data via a server device 22 which is located on or off the premises.

In one particular embodiment, a signal 24 is received by a Duty Manager from the monitoring device 16 by means of a remote paging receiver device 26. On receipt of this signal, the Duty manager can dispatch a member of staff to the shelving location of interest to either assist a customer in loading the protected merchandise is onto a trolley in preparation to be taken to a point of sale and purchased, or to intercept theft or damage to the item.

Further changes can be made within the scope of the invention.

1. A system for detecting removal of an item from storage shelving, the system comprising:
one or more sensors located on the storage shelving where items are positioned, each sensor being located so as to be associated with a single item, and each sensor being operable in response to movement of an associated item to generate a system signal including the location of that sensor; and
a monitoring device to which the sensors are connected, configured to receive the system signal and to generate a predetermined warning signal in response to the system signal.

2. A system as claimed in claim 1, wherein the monitoring device is also configured to output data to a web-based reporting system when the warning signal is generated.

3. A system as claimed in claim 1, wherein the monitoring device is configurable to output one or more of a set of predetermined warning signals.

4. A system as claimed in claim 1, wherein the warning signal includes an electronic message alert to an operator.

5. A system as claimed in claim 1, wherein the warning single includes at least one of an audible signal and a visual signal.

6. A system as claimed in claim 5, wherein the warning signal is generated at or near to the location of the sensor that has generated the system signal leading to the warning signal.

7. A method of detecting removal an item from storage shelving, the method comprising:
operating one or more sensors located on the storage shelving where items are positioned, wherein each sensor is located so as to be associated with a single item, to generate a system signal in response to movement of the item, the system signal including the location of the sensor associated with the item being moved;
receiving the system signal at a monitoring device to which the sensors are connected; and
generating a predetermined warning signal in response to the system signal.

8. A method as claimed in claim 7, further comprising outputting data to a web-based reporting system when the warning signal is generated.

9. A method as claimed in claim 7, comprising outputting one or more of a set of predetermined warning signals from the monitoring device.

10. A method as claimed in claim 7, wherein the step of generating a predetermined warning signal includes sending an electronic message alert to an operator.

11. A method as claimed in claim 7, comprising generating at least one of an audible signal and a visual signal as the warning signal.

12. A method as claimed in claim 11, comprising generating the warning signal at or near to the location of the sensor that has generated the system signal leading to the warning signal.
